(19) United States
(12) Patent Application Publication
(10) Pub. No.: US 2025/0259609 A1
(43) Pub. Date: Aug. 14, 2025

(54) MOUTHPIECE AND HEAD JOINT FOR WOODWIND MUSICAL INSTRUMENTS

(71) Applicant: Howard An, Glenview, IL (US)

(72) Inventor: Howard An, Glenview, IL (US)

(21) Appl. No.: 18/436,528

(22) Filed: Feb. 8, 2024

(51) Int. Cl. G10D 9/03; G10D 7/066

(52) U.S. Cl. CPC G10D 9/03; G10D 7/066

(57) ABSTRACT

A woodwind adaptor for woodwind musical instruments that enables a reed instrument to sound like an end-blown flute instrument. The woodwind adaptor replaces the standard reed-housing mouthpiece of the reed instrument with a recorder-style adaptor having a tone hole, whereby the tonal qualities through the reed instrument are, in part, propagated by the player's urged air stream over the edge of the tonal hole.

### BACKGROUND OF THE INVENTION

The present invention relates to woodwind musical instruments and, more particularly, to a woodwind adaptor for woodwind musical instruments that enables a reed instrument to sound like an end-blown flute.

A musician or aspiring musician interested in playing both the clarinet (a reed instrument) and the recorder (an internal duct flute) currently needs to buy or rent both instruments separately, which is expressive. And if the musician decides they are no longer interested in one of the musical instruments, then they are out of luck and need to resell or return the instrument. If there were a woodwind adaptor to enable a clarinet to be played to make sounds like that of a recorder, then this problem could be averted.

There are many woodwinds musical instruments, and the clarinet and the flute are the most common. The clarinet is a single reed-type woodwind instrument where the player's breath is directed against a reed (or lamella) which vibrates the read/lamella to produce sound, while the flute produces sound with a vibrating column of air, via an airstream urged by the player at or over the edge of the aperture disposed at or adjacent the end of the longitudinal instrument.

Furthermore, some woodwind instruments, like the shakuhachi, are a challenge to produce intentional tone from, and accidentals like flats and sharps are equally demanding. A shakuhachi-like mouthpiece attached to the clarinet can improve the ease of playing many notes and produce unique tones; however, such an item does not exist in the prior art. Also, a brass horn mouthpiece, like the trumpet, attached to the clarinet can produce a unique tone.

As can be seen, there is a need for a woodwind adaptor for woodwind musical instruments that enables a reed instrument to sound like an end-blown flute, and possibly vice versa.

### SUMMARY OF THE INVENTION

The woodwind adaptor of the present invention provides a mouthpiece and head joint, thereby enabling operative association between the woodwind adaptor and a clarinet so that a player thereof can produce flute sounds or tones on the clarinet without having to purchase a flute.

The present invention can help woodwind instrument players mimic the sound of another woodwind instrument without learning to play the other woodwind instrument.

The present invention embodies a unique mouthpiece or flute head joint that can be attached to the clarinet body so that directing an airstream through the mouthpiece produces a unique flute tone without the reed.

In aspect of the present invention, adaptor for a reed woodwind instrument, the adaptor includes the following: a connection tube extending from a first end to a second end; a mouthpiece fluidly coupled to the first end; the second end configured to associate with the reed woodwind instrument so that a flow of air urged through the mouthpiece enters a body of the reed woodwind instrument; and a tonal ramp disposed between the first and second ends of the connection tube.

In another aspect of the present invention, the adaptor for a reed woodwind instrument further includes wherein the mouthpiece is a recorder-style mouthpiece having an arcuate ring dimensioned and shaped to engage an outer surface of the connection tube so that the arcuate ring can be rotated about said outer surface, whereby rotating the arcuate ring selectively closes off, at least a portion, of the tonal ramp.

In yet another aspect of the present invention, a method of converting a reed woodwind instrument to a flute woodwind instrument, the method includes the following: removing a reed mouthpiece from the reed woodwind instrument; and replacing the reed mouthpiece with the above-mentioned adaptor of, wherein the mouthpiece is a shakuhachi-style mouthpiece having a tonal hole for producing tones by direct an air flow across an edge of the tonal hole, or wherein the mouthpiece is a flute-style mouthpiece having a tonal hole for producing tones by direct an air flow across an edge of the tonal hole. In another aspect of the present invention, a modified brass horn-style mouthpiece can replace the reed mouthpiece, in which the player's vibrating lips by the air flow will produce a unique tone.

These and other features, aspects and advantages of the present invention will become better understood with reference to the following drawings, description, and claims.

### BRIEF DESCRIPTION OF THE DRAWINGS

FIG. 1 is a perspective view of an exemplary embodiment of a recorder-style adaptor 10 of the present invention.

FIG. 2 is an exploded perspective view of an exemplary embodiment of the present invention, illustrating replacing a standard reed mouthpiece 20 with the record-style adaptor 10, wherein the reed housed in the standard reed mouthpiece 20 is replaced by the internal ductwork of the record-style adaptor 10 to direct the air stream across the edge of a tone hole. It being understood that there are other adaptors of the present invention that may not have an internal duct, but may have other end-blown tone holes or other non-reed arrangements that direct the player's air stream or experiences the air stream across an edge of the tone hole.

FIG. 3 is an exploded perspective view of an exemplary embodiment of the record-style adaptor 10 of the present invention, illustrating connecting the connection clip 16.

FIG. 4 is a perspective view of an exemplary embodiment of the recorder-style adaptor 10 of the present invention, shown in an installed condition on a reed instrument 18.

FIG. 5 is a perspective view of an exemplary embodiment of the recorder-style adaptor 10 of the present invention, illustrating turning the connection clip 16 to reduce an opening of tonal ramp 12.

FIG. 6 is a perspective view of an exemplary embodiment of a shakuhachi-style adaptor 22 of the present invention.

FIG. 7 is a perspective view of an exemplary embodiment of the shakuhachi-style adaptor 22 of the present invention, shown installed on a reed instrument 18.

FIG. 8 is a perspective view of an exemplary embodiment of a flute-style adaptor 26 of the present invention.

FIG. 9 is a perspective view of an exemplary embodiment of the present invention, illustrating the flute-style adaptor 26 installed on the reed instrument 18.

FIG. 10 is a perspective view of an exemplary embodiment of a brass horn-style adaptor 34 of the present invention.

FIG. 11 is a perspective view of an exemplary embodiment of the brass horn-style adaptor 34 of the present invention, shown installed on a reed instrument 18.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides woodwind adaptor for woodwind musical instruments that enables a reed instrument to sound like an end-blown flute by replacing the reed mouthpiece with a flute mouthpiece. The woodwind adaptor for woodwind musical instruments enables a reed instrument to sound like an end-blown flute instrument. The woodwind adaptor replaces the standard reed-housing mouthpiece of the reed instrument with a recorder-style adaptor having a tone hole, whereby the tonal qualities through the reed instrument are, in part, propagated by the player's urged air stream over the edge of the tonal hole.

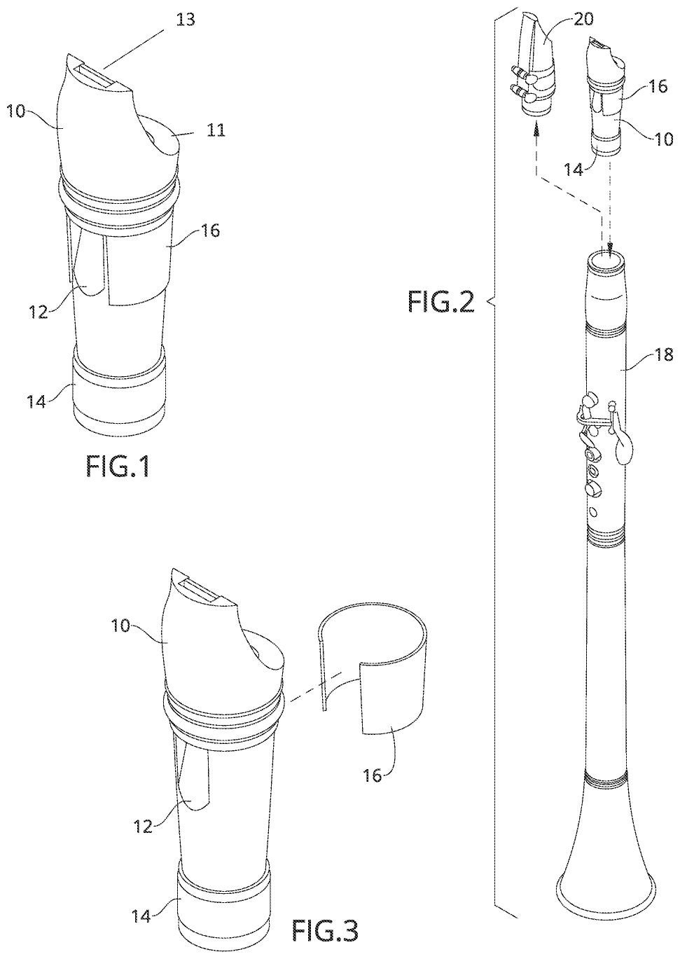

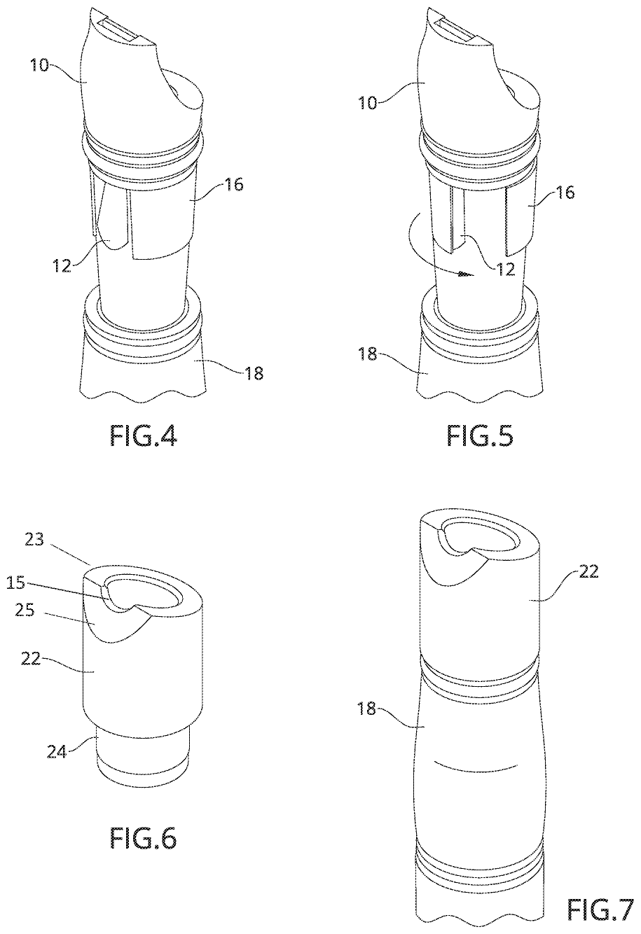

Referring to FIGS. 1 through 5, the present invention includes a recorder-style adaptor 10. The recorder-style adaptor 10 provides a recorder-style mouthpiece 11 fluidly coupled to a connection post 14. The connection post 14 is dimensioned and adapted to slide into an open end of a reed instrument 18.

The air stream, urged by the player through the inlet opening 13 of the recorder-style adaptor 10, is affected by the shaping of the surfaces in the recorder-style adaptor 10 (the “voicing”), and the also affected by how the player blows air into the windway. Among other parameters, recorder voicing is determined by physical parameters such as the proportions and curvature of the windway along both the longitudinal and latitudinal axes, the beveled edges (chamfers) of the windway facing towards the labium, the length of the window, the steepness and opening of the tonal ramp 12 that is disposed between the recorder-style mouthpiece 11 and a distal end of the connection post 14.

The recorder-style adaptor 10 further includes an arcuate clip 16 dimensioned and sized to resiliently (possibly based on its material type and the difference in its inner diameter and the outer diameter of the connection post 14) engage the connection post 14, adjacent the tonal ramp 12, so that the arcuate clip 16 is rotatable about that portion of the connection post 14 it engages. As a result, a user could selectively rotate the arcuate clip 16 so selectively adjust the opening of the tonal ramp 12, as illustrated in FIG. 5, thereby affecting the tonal parameters of the recorder-style adaptor 10.

Referring to FIGS. 6 and 7, the present invention includes a shakuhachi-style adaptor 22. The shakuhachi-style adaptor 22 has a shakuhachi-style mouthpiece 23 fluidly coupled to a connection post 24. The connection post 14 is dimensioned and adapted to slide into an open end of a reed instrument 18. The shakuhachi-style mouthpiece 23 has a sharp blowing edge 25, adjacent a tonal hole 15, to blow against for producing the desire tone and sound.

As a result, the present invention can make the clarinet, which is a reed vibrating instrument to transform into an airflow instrument like a shakuhachi, flute or trumpet.

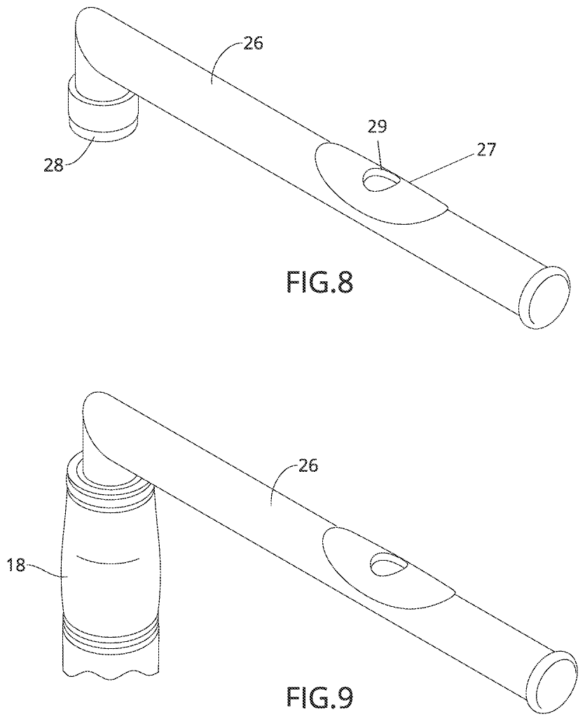

Referring to FIGS. 8 and 9, the present invention includes a flute-style adaptor 26. The flute-style adaptor 22 has a flute-style mouthpiece 27 with a tonal hole 29 fluidly coupled to a connection post 18. The connection post 28 is dimensioned and adapted to slide into an open end of a reed instrument 18.

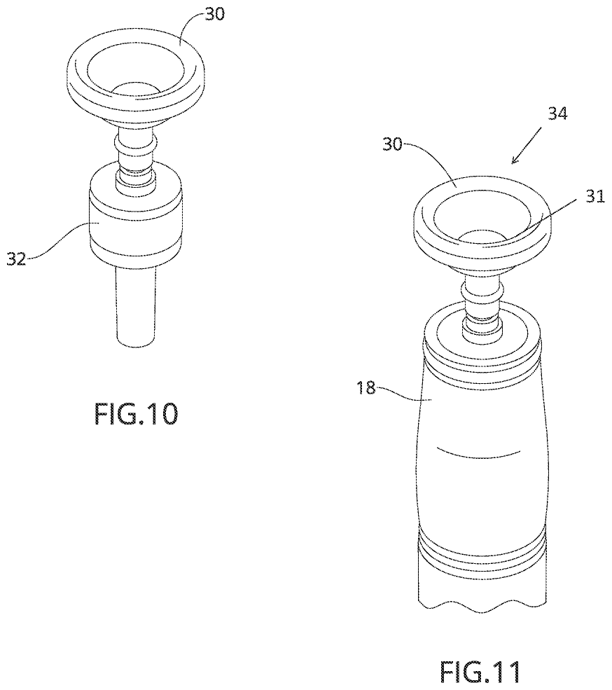

Referring to FIGS. 10 and 11, the present invention includes a brass horn-style adaptor 30. The brass horn-style adaptor 34 has a brass horn-style mouthpiece with a tonal hole 31 fluidly coupled to a connection post 32. The connection post 32 is dimensioned and adapted to slide into an open end of a reed instrument 18, such as a clarinet.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. An adaptor for a reed woodwind instrument, the adaptor comprising:
a connection tube extending from a first end to a second end;
a mouthpiece fluidly coupled to the first end;
the second end configured to associate with the reed woodwind instrument so that a flow of air urged through the mouthpiece enters a body of the reed woodwind instrument; and
a tonal ramp disposed between the first and second ends of the connection tube.

2. The adaptor of claim 1, wherein the mouthpiece is a recorder-style mouthpiece.

3. The adaptor of claim 2, further comprising:
an arcuate ring dimensioned and shaped to engage an outer surface of the connection tube so that the arcuate ring can be rotated about said outer surface, whereby rotating the arcuate ring selectively closes off, at least a portion, of the tonal ramp.

4. The adaptor of claim 1, wherein the mouthpiece is a shakuhachi-style mouthpiece having a tonal hole for producing tones by directing an air flow across an edge of the tonal hole.

5. The adaptor of claim 1, wherein the mouthpiece is a brass-horn-style mouthpiece having a tonal hole for producing tones by directing an air flow across an edge of the tonal hole.

6. The adaptor of claim 1, wherein the mouthpiece is a flute-style mouthpiece having a tonal hole for producing tones by directing an air flow across an edge of the tonal hole.

7. A method of converting a reed woodwind instrument to a flute woodwind instrument, the method comprising:
removing a reed mouthpiece from the reed woodwind instrument; and
replacing the reed mouthpiece with the adaptor of claim 1.

8. A method of converting a reed woodwind instrument to a brass horn-style instrument like the trumpet, the method comprising: removing a reed mouthpiece from woodwind instrument; and replacing the reed mouthpiece with the adaptor of claim 1.
